(19) United States
(12) Patent Application Publication
(10) Pub. No.: US 2020/0379625 A1
(43) Pub. Date: Dec. 3, 2020

(54) AUGMENTED SYSTEM AND METHOD FOR MANIPULATING FURNITURE

(71) Applicant: Qingshan Wang, Chino Hills, CA (US)

(72) Inventor: Qingshan Wang, Chino Hills, CA (US)

(21) Appl. No.: 16/719,712

(22) Filed: Dec. 18, 2019

Related U.S. Application Data
(60) Provisional application No. 62/854,852, filed on May 30, 2019.

(51) Int. Cl. G06F 3/0481; G06F 3/0484; G06F 3/0485

(52) U.S. Cl. CPC G06F 3/04815; G06F 3/04845; G06F 2203/04806; G06F 3/0485; G06F 3/04842

(57) ABSTRACT

An augmented system and method for manipulating furniture creates an interactive experience through a real-world environment where three-dimensional virtual architectural objects, such as furniture, are viewable and manipulated. The three-dimensional virtual architectural objects are stored in a website, and accessible for displaying in a virtual reality environment. A user-controlled virtual viewing device is provided for viewing the virtual reality environment. A virtual control handle is also provided to the user for selecting at least one of the virtual architectural objects. A virtual reality program is installed in the viewing device, so as to enable the user to navigate and select virtual architectural objects, visually enhance the virtual architectural objects, and manipulate the virtual architectural objects. This can be useful for premeasuring dimensions, and planning the context of the virtual architectural objects in the virtual reality environment, before physically moving furniture in a real-world environment.

### CROSS REFERENCE OF RELATED APPLICATIONS

This application claims the benefits of U.S. provisional application no. 62/854,852, filed May, 30, 2019 and entitled METHOD AND SYSTEM FOR INTERACTIVE THREE-DIMENSIONAL OBJECT, which provisional application is incorporated by reference herein in its entirety.

### FIELD OF THE INVENTION

The present invention relates generally to an augmented system and method for manipulating furniture. More so, the present invention relates to a system and method that provides interactive experience through a real-world environment where three-dimensional virtual architectural objects, such as furniture, are stored in a website, and accessible for displaying in a virtual reality environment; whereby a user-controlled virtual viewing device is provided for viewing the virtual reality environment; and a virtual control handle is also provided to the user for selecting at least one of the virtual architectural objects from the website for positioning in the virtual reality environment.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, augmented reality provides a platform having technologies that merge real-world and virtual elements to produce new visualizations through a video, where physical and digital objects co-exist and interact in real time. Often, such 3D elements are virtual elements that can be visualized in augmented reality. It is known in the art that the number of online shoppers is growing due to the improvement of the internet environment due to the development of internet technology. As a result, sites providing various services on the internet are emerging, the most representative of which is an internet shopping mall.

Online furniture shoppers experience numerous challenges when purchasing products. Any given purchase will be influenced by a host of factors, including appearance, style, price, value, and quality. A significant number of consumers, especially those searching for home furnishings, search for information online.

A drawback of searching for home furnishings online relies on the difficulty consumers have in visualizing any particular item in the context of one's home, and in the context of Surrounding items. Thus, there may exist a desire to utilize a virtual reality method and system to display the products, so as to facilitate the customers making purchases.

Those skilled in the art will recognize that challenges faced by the home furnishing industry is that, although customers can understand the style of house decoration and decoration from the graphic design and interior design, the customer cannot directly feel the furniture. This results in customers having to redecorate multiple times before achieving a desired arrangement and look. The furniture retail industry also faces similar challenges. In online stores, customers who consume in physical stores are often troubled by physical delivery and different effects and expectations.

Other proposals have involved virtual reality systems where the user can view and move objects. The problem with these virtual reality systems is that they do not allow the user to select, change, delete, and duplicate furniture onto a virtual reality environment. Also, a viewing device and a virtual control handle are not used in conjunction with VR software to achieve optimal results. Even though the above cited virtual reality systems meet some of the needs of the market, an augmented system and method for manipulating furniture that provides interactive experience through a real-world environment where three-dimensional virtual architectural objects, such as furniture, are stored in a website, and accessible for displaying in a virtual reality environment; whereby a user-controlled virtual viewing device is provided for viewing the virtual reality environment; and a virtual control handle is also provided to the user for selecting at least one of the virtual architectural objects from the website for positioning in the virtual reality environment, is still desired.

### SUMMARY

Illustrative embodiments of the disclosure are generally directed to an augmented system and method for manipulating furniture. The augmented system and method creates an interactive experience through a real-world environment where three-dimensional images of computer-generated perceptual information are viewable and manipulated. The computer-generated perceptual information includes three-dimensional virtual architectural objects, such as furniture, that are stored in a web site, and accessible for displaying in the virtual reality environment. The virtual architectural objects are accessible from the web site and easily drop into the virtual reality environment where the user can measure, orient, highlight, and generally manipulate the virtual architectural objects to a desired arrangement.

In some embodiments, a user-controlled virtual viewing device is provided for viewing the virtual reality environment, and the virtual architectural objects contained therein. A virtual control handle is also provided to the user for selecting, highlighting, and manipulating the virtual architectural objects. A virtual reality program is installed in the viewing device, so as to enable the user to navigate and select virtual architectural objects, visually enhance the virtual architectural objects, and manipulate the virtual architectural objects. This can be useful for premeasuring dimensions, and planning the context of the virtual architectural objects in the virtual reality environment, before physically moving furniture and the like to a real-world environment.

Thus, the virtual architectural objects can be selected from a website, and then manipulated into a desired position in the virtual reality environment. This works to create a virtual reality/augmented reality augmented reality/mixed reality immersive experience for the user. This virtual reality environment, and the manipulation of virtual architectural objects therein is useful for virtual selection, placement, and manipulation of furniture, electronics, and other objects in the virtual reality environment.

In some embodiments, the augmented method for manipulating furniture may include an initial Step of generating a plurality of three dimensional virtual architectural objects in a data storage device.

Another Step comprises displaying the three-dimensional virtual architectural objects on a network web resource.

The method may include another Step of scanning a real-world environment to generate an image, the image comprising a virtual reality environment corresponding to the real-world environment;

A further Step comprises Step of rendering the image and the three-dimensional virtual architectural objects into the virtual reality program.

A Step includes installing the virtual reality program into a user-controlled virtual viewing device, whereby the virtual reality environment and the three-dimensional virtual architectural objects are viewable through the user-controlled virtual viewing device.

In some embodiments, a Step comprises virtually navigating the virtual reality environment through the user-controlled virtual viewing device.

A Step comprises operatively connecting a user-controlled virtual control handle with the user-controlled virtual viewing device, the virtual control handle being operable to highlight and manipulate the virtual architectural objects viewed through the virtual viewing device.

The method may further comprise a Step of selecting, with the virtual control handle, the three-dimensional virtual architectural objects from the network web resource.

A final Step includes manipulating the selected three-dimensional virtual architectural objects to a desired position in the virtual reality environment.

In another aspect, the three-dimensional virtual architectural objects comprise furniture.

In another aspect, the data storage device includes at least one of the following: a server, a database, a cloud server, and a network.

In another aspect, the virtual reality environment includes at least one of the following: a furniture showroom, a furniture store, and a furniture auction site.

In another aspect, the three-dimensional virtual architectural objects represent a mathematical representation of points and surfaces in the virtual reality environment that a rendering engine can translate into three dimensions.

In another aspect, the image comprises a video of the virtual reality environment.

In another aspect, the method further comprises a step of viewing, through the virtual viewing device, the virtual reality environment and the virtual architectural objects from at least one perspective view.

In another aspect combinable with the general implementation, the method further comprises a step of receiving a selection of the selectable object to place an order of the selected object.

In another aspect combinable with the general implementation, the method further step of obtaining additional information regarding the selectable objects.

In another aspect combinable with the general implementation, at least one of the virtual reality environment is built from a plurality of images representing different views of the physical scene.

In another aspect combinable with the general implementation, at least one of the virtual reality environment can be observed from one or more perspectives.

In another aspect combinable with the general implementation, at least one of the user selects the selectable objects using a computing device.

Another aspect of the embodiment is directed to a system of interacting three-dimensional object display, comprising;

a server; and a client terminal communicating with the server to: provide video to continuously display a virtual reality environment corresponding to a physical scene including a plurality of objects; enable a user to navigate within the virtual reality environment; and display a selectable object within the virtual reality environment.

One objective of the present invention is to use the most advanced VR/AR/MR (virtual reality/augmented reality augmented reality/mixed reality) immersive experience.

Another objective is to allow the user to select from different types of furniture, so as to visually imagine the customization of a room before physically moving the furniture into the real-world environment.

Yet another objective is to facilitate interior design placement and planning.

Yet another objective is to utilize technology to enhance a customer's experience in purchasing furniture and housing design, decoration, and decoration.

Yet another objective is to virtually position furniture in a room, and virtually obtain measurements of the room and the furniture.

Yet another objective is to provide wearable devices that are used to view and manipulate objects in the virtual reality environment.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a flowchart of an exemplary augmented method for manipulating furniture, in accordance with an embodiment of the present invention;

FIG. 2 illustrates a flowchart of an alternative embodiment of an augmented method for manipulating furniture, in accordance with an embodiment of the present invention;

FIG. 3 illustrates a block diagram of an exemplary augmented method for manipulating furniture, in accordance with an embodiment of the present invention;

FIG. 4 illustrates a perspective view of an exemplary augmented system for manipulating furniture, showing a user donning a virtual viewing device and controlling a virtual control handle, in accordance with an embodiment of the present invention;

FIG. 5 illustrates a perspective view of the augmented system for manipulating furniture, showing the virtual control handle emitting a light towards a virtual architectural object, in accordance with an embodiment of the present invention;

FIG. 6 illustrates a perspective view of the augmented system for manipulating furniture, showing the selection of a function for manipulation of the virtual architectural object, in accordance with an embodiment of the present invention;

FIG. 7 illustrates a perspective view of the augmented system for manipulating furniture, showing a web site visible to the user for selecting from virtual architectural objects, in accordance with an embodiment of the present invention;

FIG. 8 illustrates a perspective view of the augmented system for manipulating furniture, showing the selection of a desk from the website, in accordance with an embodiment of the present invention;

FIG. 9 illustrates a perspective view of the augmented system for manipulating furniture, showing the placement of the desk into the virtual reality environment, in accordance with an embodiment of the present invention; and

FIG. 10 illustrates a perspective view of the augmented system for manipulating furniture, showing the user lifting the desk by raising the virtual control handle, in accordance with an embodiment of the present invention.

Like reference numerals refer to like parts throughout the various views of the drawings.

### DETAILED DESCRIPTION OF THE INVENTION

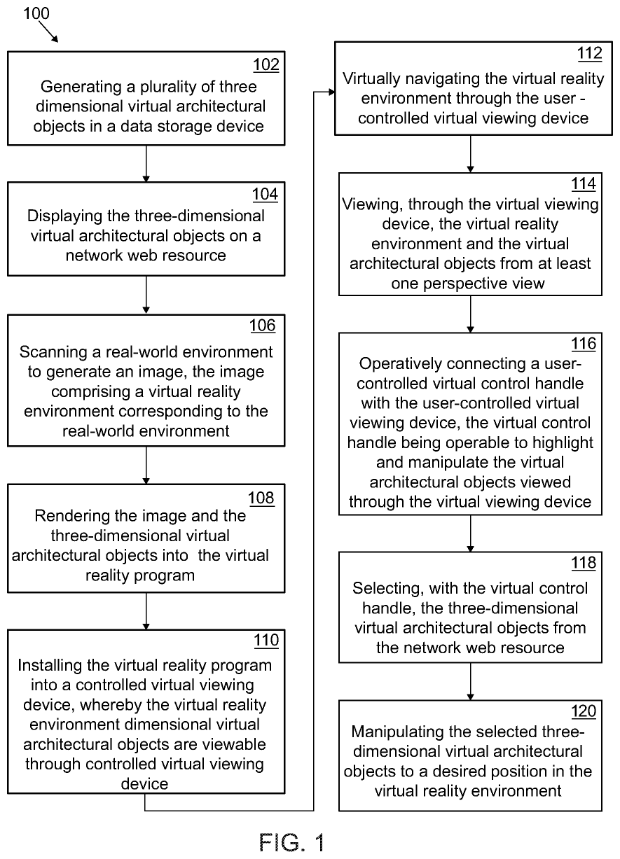

The following detailed description is merely exemplary and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An augmented system 200 and method 100 for manipulating furniture is referenced in FIGS. 1-10. The augmented system 200 and method 100 create an interactive experience through a real-world environment 400 where three-dimensional images of computer-generated perceptual information are viewable and manipulated. The computer-generated perceptual information can be rendered as three-dimensional virtual architectural objects 408a-e, such as furniture.

The virtual architectural objects 408a-e are digitally stored in a data storage device 210 for displaying on a website. From the website, a user 410 may select and access one or more of the virtual architectural objects 408a-e for positioning, measuring, orienting, and generally manipulating throughout the virtual reality environment 402. The virtual architectural objects 408a-e are accessible from the website and easily drop into the virtual reality environment 402. In one embodiment, the three-dimensional virtual architectural objects 408a-e represent a mathematical representation of points and surfaces in the virtual reality environment 402 that a rendering engine can translate into three dimensions.

The virtual reality environment 402 is viewable by a user 410 with a virtual viewing device 404, which may utilize optics, depth perception algorithms, and video programs for operation thereof. In some embodiments, the virtual viewing device 404 may include a virtual reality, an augmented reality or a mixed reality. The user-controlled virtual viewing device 404 is configured for donning, while simultaneously viewing the virtual reality environment 402.

The user may view the virtual reality environment 402 from multiple points of view, perspectives, and orientations. The user 410 may also scroll right across the virtual reality environment 402, scroll up across the virtual reality environment 402, scroll down across the virtual reality environment 402, zoom-in from the virtual reality environment 402, and zoom-out to the virtual reality environment 402 for enhanced viewing of the virtual architectural objects 408a-e.

Further, the method 100 allows for a unique virtual control handle 406, which provided to the user 410 for selecting, highlighting, and manipulating the virtual architectural objects 408a-e. In some embodiments, a virtual reality program is installed in the virtual viewing device 404, so as to enable the user 410 to navigate and select virtual architectural objects 408a-e, visually enhance the virtual architectural objects 408a-e, and manipulate the virtual architectural objects 408a-e.

This can be useful for premeasuring dimensions, and planning the context of the virtual architectural objects 408a-e in the virtual reality environment 402, before physically moving furniture and the like to a real-world environment 400. In one non-limiting embodiment, the virtual reality program 214 is operable with a rendered engine 212. The virtual reality program 214 may utilize augmented technology, including: Vuforia Augmented Reality SDK, and OpenGL.

Thus, the virtual architectural objects 408a-e can be selected from a website, and then manipulated into a desired position in the virtual reality environment 402. This works to create a virtual reality/augmented reality augmented reality/mixed reality immersive experience for the user 410. This virtual reality environment 402, and the manipulation of virtual architectural objects 408a-e therein is useful for virtual selection, placement, and manipulation of furniture, electronics, and other objects in the virtual reality environment 402.

Those skilled in the art will recognize that challenges faced by the home furnishing industry is that, although customers can understand the style of house decoration and decoration from the graphic design and interior design, the customer cannot directly feel the furniture. This results in customers having to redecorate multiple times before achieving a desired arrangement and look. The furniture retail industry also faces similar challenges. In online stores, customers who consume in physical stores are often troubled by physical delivery and different effects and expectations.

As referenced in flowchart of FIG. 1, the augmented method 100 for manipulating furniture may include an initial Step 102 of generating a plurality of three dimensional virtual architectural objects 408a-e in a data storage device. The three-dimensional virtual architectural objects 408a-e may include furniture, objects of art, electrical components, and other design members known in the art. Typical furniture used by interior designers may include a sofa 408a, a desk 408b, and a picture 408c.

Such architectural objects are based on real-world objects that are imaged/scanned to generate a corresponding virtual version thereof. However, in the virtual environment, the attributes of the furniture may be instantly changed to achieve a desired look. The virtual architectural objects 408a-e are stored in a data storage device for access by the user from a website or online store. The data storage device 210 is used to store, and enable access to the virtual architectural objects 408a-e. In some embodiments, the data storage device may include, without limitation, a server, a database, a cloud server, and a network.

In one non-limiting embodiment, the attributes of the virtual architectural objects 408a-e, which are viewable throughout the virtual reality environment 402, include eclectic colors and sizes of furniture, surrounding walls, ceilings, and walls. Furthermore, the virtual reality environment 402 corresponds to a real-world environment 400, which may include: a furniture showrooms, a furniture store, a furniture auction site, a house, an apartment, a commercial building, a warehouse, a garden, and a building structure.

Another Step 104 comprises displaying the three-dimensional virtual architectural objects 408a-e on a network web resource 700. The network web source 700 may include a website, or an online store from which the user can select various types of virtual architectural objects 408a-e for placement and manipulation in the virtual reality environment 402. The network web source 700 appears directly in front of the user in the virtual reality environment 402.

Another Step 106 comprises scanning a real-world environment 400 to generate an image, the image comprising a virtual reality environment 402 corresponding to the real-world environment 400. In another aspect, the image comprises a video of the virtual reality environment 402. The real-world environment 400 may include a target house, where the user requires designing and decorating functions. In one embodiment, a 3D scanner, using known scanning technology, is used to scan the real-world environment 400, including the house and the room structure to obtain the complete 3D structure of the real-world environment 400.

The method 100 may further comprise a Step 108 of rendering the image and the three-dimensional virtual architectural objects 408a-e into the virtual reality program. The resulting image of the scanned structure map is imported into a virtual reality software to create a virtual house structure that can be explored in the virtual reality environment 402 and is consistent with the real-world environment 400. In some embodiments, the method 100 is operable so that 3D models of all architectural objects 408a-e can be imported into the virtual reality environment 402. In some embodiments, a designer provides a number of interior design drafts according to customer needs, and then use the imported 3D model to create a virtual reality room with decoration and furniture.

A Step 110 includes installing the virtual reality program into a user-controlled virtual viewing device 404, whereby the virtual reality environment 402 and the three-dimensional virtual architectural objects 408a-e are viewable through the user-controlled virtual viewing device 404. In one non-limiting embodiment, the virtual reality program is operable with a rendered engine. The virtual reality program may utilize augmented technology, including: Vuforia Augmented Reality SDK, and OpenGL.

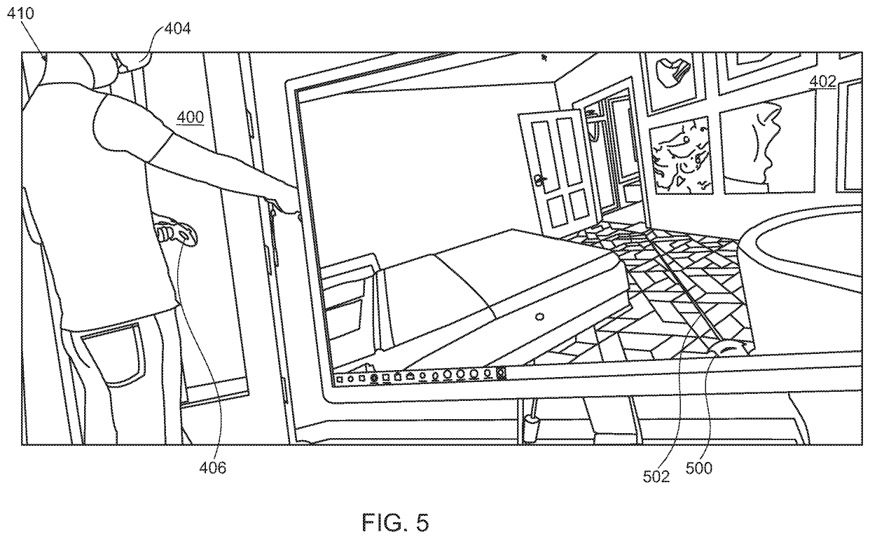

In some embodiments, a Step 112 comprises virtually navigating the virtual reality environment 402 through the user-controlled virtual viewing device 404. In alternative embodiments, an additional Step may include visually enhancing the three-dimensional virtual architectural objects 408a-e through the user-controlled virtual control handle 406. This may be performed by emitting a laser or illumination 502 emitted by a virtual image of the control handle 500, pointed at or towards the virtual architectural objects 408a-e (See FIG. 5).

Another Step 114 includes viewing, through the virtual viewing device 404, the virtual reality environment 402 and the virtual architectural objects 408a-e from at least one perspective view. In some embodiments, the user may utilize virtual reality glasses, control handles, mobile phones and other hardware equipment to explore the above VR indoor environment, users can increase or decrease furniture at any time during the exploration process.

A Step 116 comprises operatively connecting a user-controlled virtual control handle 406 with the user-controlled virtual viewing device 404, the virtual control handle 406 being operable to highlight and manipulate the virtual architectural objects 408a-e viewed through the virtual viewing device 404. Through the virtual control handle 406, the virtual architectural objects 408a-e are changeable objects, including changes in the location, style, color, and size of the object. The virtual control handle 406 allows the user to select a desired virtual architectural object in the virtual reality environment 402.

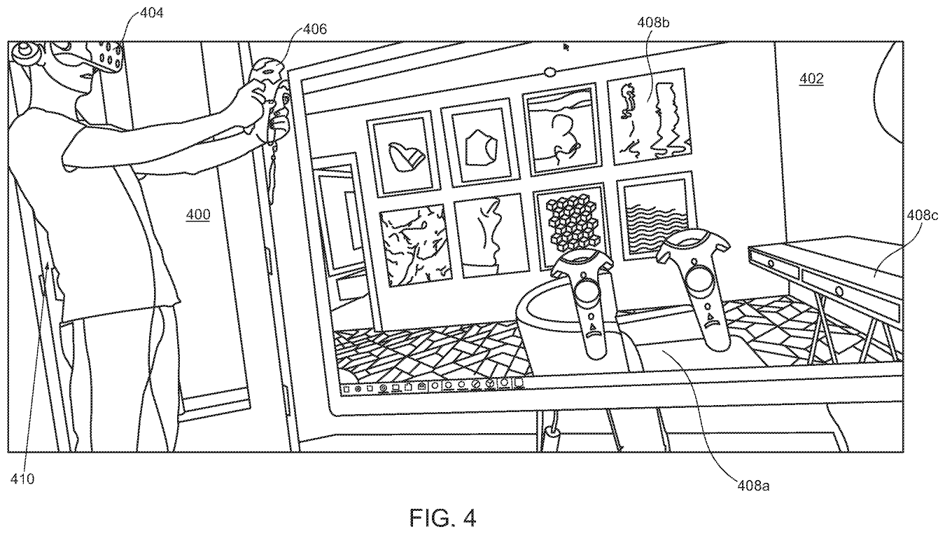

As FIG. 4 shows, the user grips one or more virtual control handle 406s. The user may then raise, lower, rotate, and depress switches to achieve a desired virtual manipulation of the virtual architectural objects 408a-e. The virtual control handle 406s may include a pair of hardware sticks operatively connected to the viewing device and the virtual reality program therein. In some embodiments, a mobile communication device, such as a smart phone, or other dedicated virtual hardware may be used.

The method 100 may further comprise a Step 118 of selecting, with the virtual control handle 406, the three-dimensional virtual architectural objects 408a-e from the network web resource. From the website, the user may select and access one or more of the virtual architectural objects 408a-e for positioning, measuring, orienting, and generally manipulating throughout the virtual reality environment 402. The virtual architectural objects 408a-e are accessible from the website and easily drop into the virtual reality environment 402. As FIG. 5 illustrates, the user may trigger a laser beam or ray of illumination to highlight or prepare positioning of the virtual architectural objects 408a-e. This highlighting means may include a red light of beam that emits from the virtual control handle 406 when the user actuates triggers.

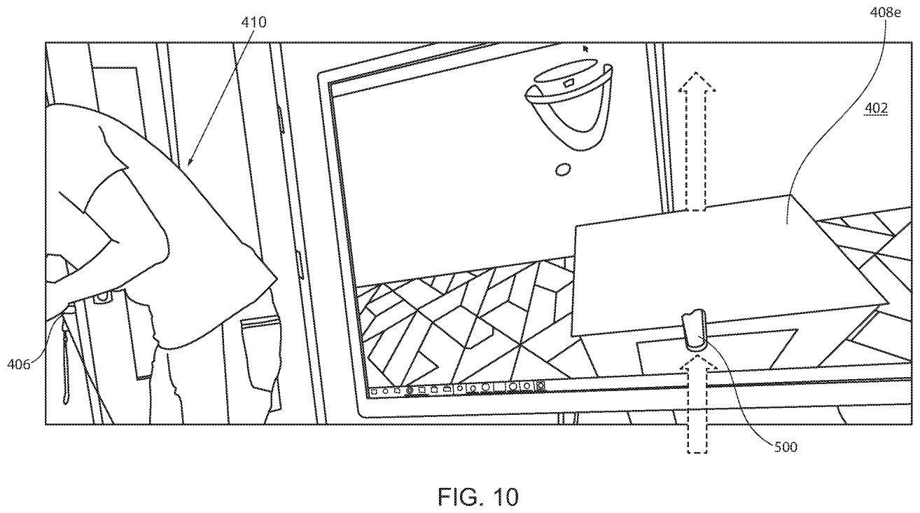

A final Step 120 includes manipulating the selected three-dimensional virtual architectural objects 408e (brown cabinet) to a desired position in the virtual reality environment 402. FIG. 10 illustrates a perspective view of the augmented system 200, showing the user lifting the desk by raising the virtual control handle. Thus, the virtual control handle 406 lifts the three-dimensional virtual architectural object 410e in a virtual room of the virtual reality environment 402. The user 410 lifts, lowers, shifts, and rotates the virtual control handle 406 to achieve a desired position or placement for the virtual architectural object 408e.

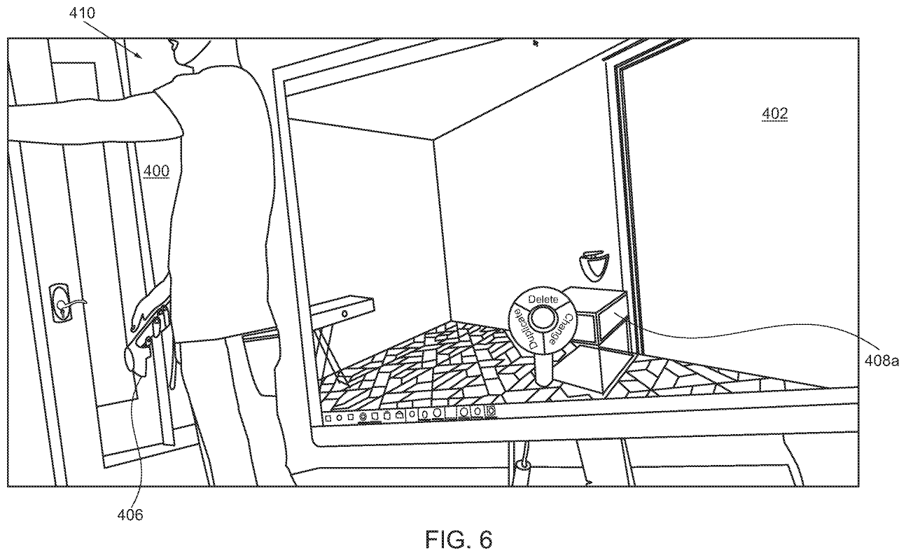

FIGS. 6-10 illustrate a user selecting and manipulating virtual architectural objects 408a-e from the network web resource. In operation, the user triggers the object selection through switches on the virtual control handle. Looking at FIG. 6 a selection mode appears, allowing the user to “duplicate”, “change”, or “delete” the virtual architectural objects, from the network web resource (website, online store), or the virtual reality environment. For example, the user can duplicate a chair in the virtual reality environment by selecting the “duplicate” option.

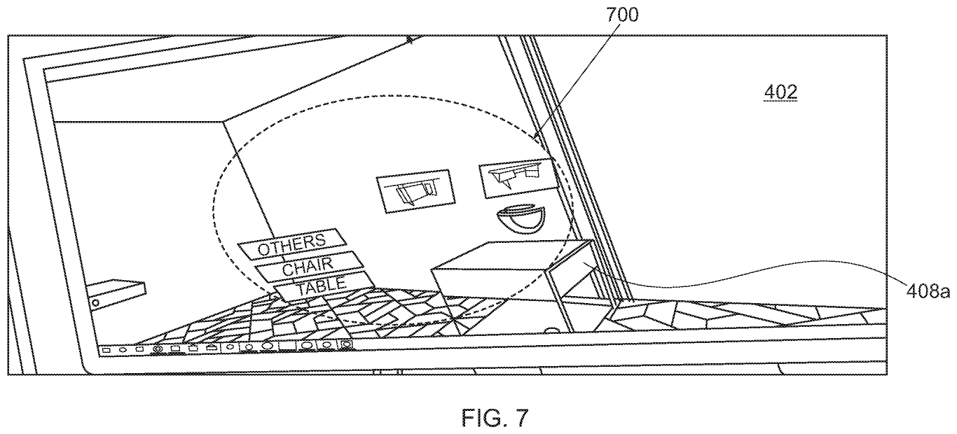

Next, an official website product page corresponding to the selected virtual architectural object appears (pops up) in view through the virtual viewing device. The product page may include a description of multiple virtual architectural objects, and their changeable attributes, which appear adjacent to the viewer. For example, as FIG. 7 shows, the user can select between a cabinet and two types of office desks. The attributes, including color, material, texture, and the like of the virtual architectural objects can also be selected from the website product page.

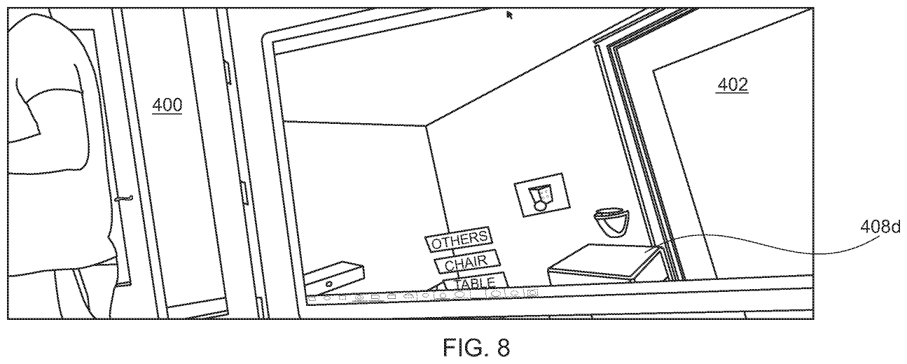

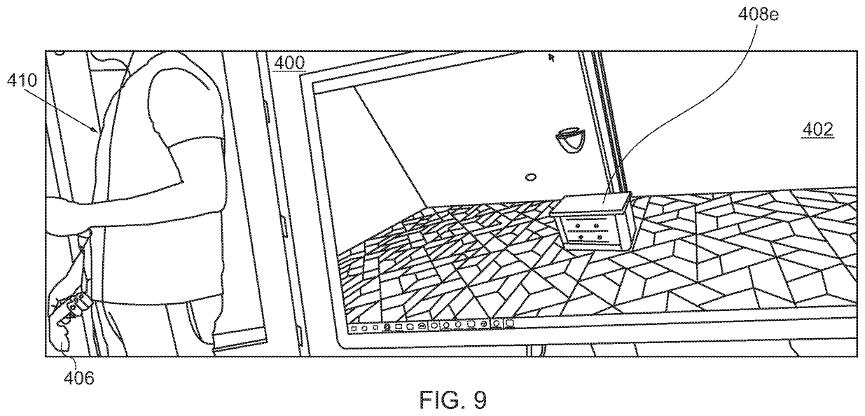

Turning now to FIG. 8, the user is shown deleting a black drawer 408d, and subsequently selecting, through switches on the virtual control handle, a cabinet 408e defined by a brown color and short legs. The virtual architectural objects in the virtual reality environment changes accordingly, based on the user's selection with the virtual control handle. Upon selection, the cabinet is viewable at the desired location selected by the user (See FIG. 9).

As discussed below, the user may subsequently rearrange the orientation, or position of the cabinet. Thus, FIG. 10 illustrates a perspective view of the virtual control handle 406 lifting the three-dimensional virtual architectural object 410e in a virtual room of the virtual reality environment 402. The user 410 lifts, lowers, shifts, and rotates the virtual control handle 406 to achieve a desired position or placement for the virtual architectural object 408e.

Another possible exemplary embodiment of the method 100 may include the following: Creating a 3D model for products in an online store. Providing a QR code for the products in a physical stores and their corresponding product pages in corresponding online stores. Next, the user imports the 3D model of the product into the above virtual reality environment in two ways: 1) Go to the online store in the virtual reality environment, browse the product page of interest, and click the Import button; and 2) Using the front lens of the virtual reality device to scan the product of interest in the real environment QR code.

In the virtual reality environment, the user adds, subtracts, and combines products imported into the virtual reality environment. The user can also join the shopping cart and checkout. For users who do not have time to move to the physical store, users will be able to launch our mobile app through their own virtual reality device, mobile phone, virtual reality app to enter the above virtual reality environment for exploration and shopping.

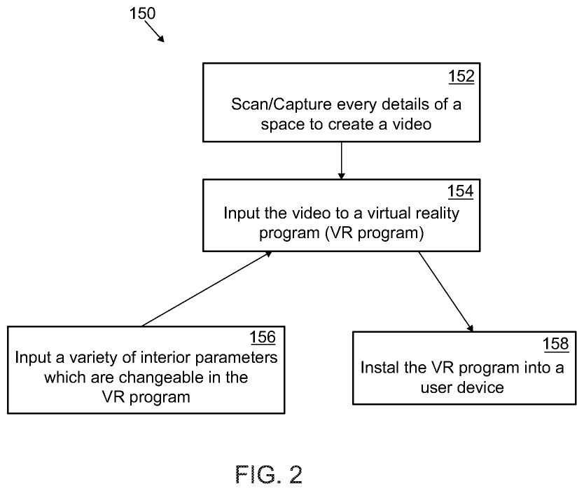

FIG. 2 depicts an alternative embodiment of the aforementioned method, referencing an augmented method 150 for manipulating furniture. The method 150 comprises steps of: scanning a space to create a video which continuously displays a virtual reality environment corresponding to a physical scene including a plurality of objects 152. An additional Step may include processing the video with a variety of interior parameters; inputting the video to a virtual reality program 154. An additional Step comprises installing the virtual reality program into a user device 158.

In one embodiment, the video can be captured by photographing or videotaping, wherein the objects are arranged within the space, wherein the video can be captured by an image capture device, such as a digital camera or 3-D scanner. Accordingly, the video may be applied to a post-production process, wherein the post-production process can select the combination of separate portions of the video, wherein the post-production process may create component-images files corresponding to each individual object present in the separate portions of the video, wherein the component-images files comprises a variety of interior parameters consisted of attributes of the furniture, attributes of the environment 156.

In yet other embodiments, the method 150 further comprises steps of: installing the VR program into a user device; enabling a user to navigate the virtual reality environment, and displaying a selectable object within the virtual reality environment. Accordingly, the user device can be selected from a group consisted of headsets, desktops, tablets, mobile phones, and glasses. In addition, the user can observe a view of the selectable object through the user device, wherein the user can scroll left, scroll right, scroll up, scroll down, zoom-in, and zoom-out within the view of the selectable object.

In another possible embodiment of method 150, the user device includes a QR code electrically communicated with the virtual reality program, wherein the user can scan the QR code and then enter the virtual reality program installed in the user device to navigate the virtual reality environment. In another embodiment, the virtual reality environment is corresponding to a physical scene, including a plurality of objects, wherein the objects can be but are not limited to different kinds of furniture.

In addition, the virtual reality environment is built from a plurality of images representing different views of the physical scene, wherein the virtual reality environment can be observed from one or more perspectives. For example, the perspectives can be captured from the left side, right side, top side, bottom side, or special angles of the selectable object. In one non-limiting embodiment, the attributes of the virtual reality environment include eclectic colors and sizes of furniture, surrounding walls, ceilings, and walls. Furthermore, the physical scene can correspond to at least one of a furniture showrooms, a furniture store, and a furniture auction site.

In yet another embodiment, shown in FIG. 5, the method 150 further comprises a step of receiving a selection of the selectable object to place an order of the selected object. In response to receiving from the user the selection of the selectable objects, the method further comprises a step of activating a link to an actionable application which allows the user to place the order of the selectable object. In still yet another embodiment, the method further comprises a step of obtaining additional information regarding the selectable objects, wherein the additional information may comprise prices, dimensions, selectable sizes and colors, and materials of the selectable objects.

In another embodiment, the method 150 further comprises a step of receiving a selection of the selectable object to place an order of the selected object. In another embodiment combinable with the general implementation, the method further step of obtaining additional information regarding the selectable objects. In another embodiment combinable with the general implementation, at least one of the virtual reality environments is built from a plurality of images representing different views of the physical scene.

In another embodiment combinable with the general implementation, at least one of the virtual reality environments can be observed from one or more perspectives. In another embodiment combinable with the general implementation, at least one of the users selects the selectable objects using a computing device. In another aspect combinable with the general implementation, at least one of the users can observe a view of the selectable object and scroll left, scroll right, scroll up, scroll down, zoom-in, and zoom-out within the view of the selectable object.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

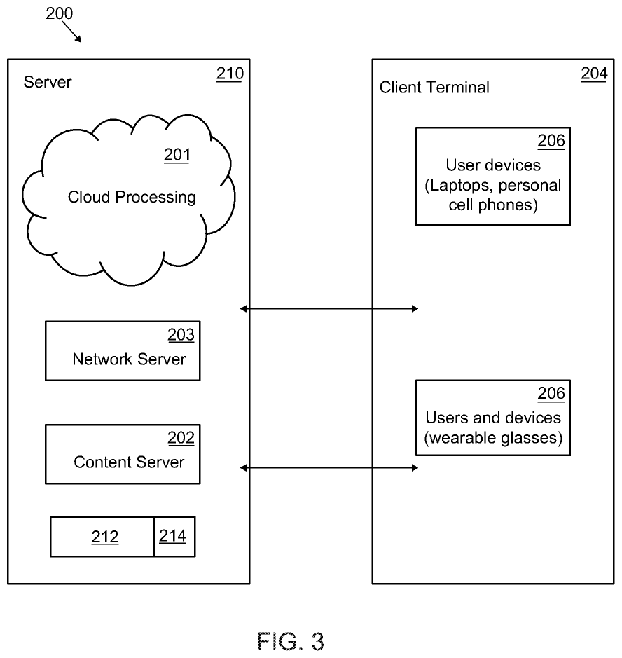

Turning now to FIG. 3, an exemplary augmented system 200 for manipulating furniture comprises a data storage device 210 operable to store a plurality of three-dimensional virtual architectural objects on a network web resource. The data storage device 210 may include a server. The system 200 also includes a client terminal 204 communicating with the data storage device 210 to: provide video to continuously display a virtual reality environment corresponding to a physical scene including a plurality of objects; enable a user to navigate within the virtual reality environment; and display a selectable object within the virtual reality environment.

In some embodiments, the system 200 may also include a user-controlled virtual control handle operatively connected to the network web resource. In other embodiments, the system 200 may include a user-controlled virtual viewing device operatively connected to the network web resource and the virtual control handle (See FIG. 4).

The system 200 further comprises a data storage device 210 and a client terminal being operable to communicate with the data storage device 210. The data storage device 210 and the client terminal 204 are configured to perform functions, such as providing a video to continuously display a virtual reality environment corresponding to a physical scene having a plurality of virtual architectural objects. Another function between the data storage device 210 and a client terminal is to enable a user to navigate within the virtual reality environment through the user-controlled virtual viewing device. Yet another function between the data storage device 210 and a client terminal is to display a selectable object within the virtual reality environment through the user-controlled virtual control handle.

Looking again at FIG. 3, the data storage device 210 comprises a cloud processing 201, a content server 202 communicating with the cloud processing, and a network server 203 communicating with the content server 202. The cloud processing 201 can be configured to store the videos, wherein the video may be applied to a post-production process to select the combination of separate portions of the video, and then generate component-images files corresponding to each individual object present in the separate portions of the video, wherein the component-images files comprises a variety of interior parameters consisted of attributes of the furniture, attributes of the environment.

The network server 203 can be configured to receive interior parameters from separate users and user devices 208, wherein the users can use the user devices 206 to input different kinds of interior parameters to the VR program, so as to change the selectable objects displayed in the VR programs and the external decoration of the environment. The system 200 for interactive three-dimensional object display further comprises steps of: receiving a selection of the selectable object to place an order of the selected object; obtaining additional information regarding the selectable objects.

In one embodiment, the users can place the orders for the selectable objects through the user devices, and also can obtain additional information, such as prices, sizes, materials, and dimensions of the selectable objects. In another embodiment, the physical scene corresponds to at least one of a furniture showrooms, a furniture store, and a furniture auction site. Therefore, the users can review the additional information of the selectable objects through the VR program and experience the 3-D dimensional objects virtually displayed in the virtual reality environment.

In conclusion, the augmented system 200 and method 100 for manipulating furniture creates an interactive experience through a real-world environment where three-dimensional virtual architectural objects, such as furniture, are viewable and manipulated. The three-dimensional virtual architectural objects are stored in a website, and accessible for displaying in a virtual reality environment. A user-controlled virtual viewing device is provided for viewing the virtual reality environment. A virtual control handle is also provided to the user for selecting at least one of the virtual architectural objects. A virtual reality program is installed in the viewing device, so as to enable the user to navigate and select virtual architectural objects, visually enhance the virtual architectural objects, and manipulate the virtual architectural objects. This can be useful for premeasuring dimensions, and planning the context of the virtual architectural objects in the virtual reality environment, before physically moving furniture in a real-world environment.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A computer-implemented augmented method for manipulating furniture, the method comprising:
displaying a plurality of three-dimensional virtual architectural objects on a network web resource;
scanning a real-world environment to generate an image, the image comprising a virtual reality environment corresponding to the real-world environment;
rendering the image and the three-dimensional virtual architectural objects into a virtual reality program;
installing the virtual reality program into a user-controlled virtual viewing device, whereby the virtual reality environment and the three-dimensional virtual architectural objects are viewable through the user-controlled virtual viewing device;
operatively connecting a user-controlled virtual control handle to the user-controlled virtual viewing device, the virtual control handle being operable to highlight and manipulate the virtual architectural objects being viewed through the virtual viewing device;
selecting, with the virtual control handle, the three-dimensional virtual architectural objects from the network web resource;
rendering the three-dimensional virtual architectural objects into the virtual reality environment; and
manipulating the selected three-dimensional virtual architectural objects.

2. The method of claim 1, further comprising a step of generating a plurality of three dimensional virtual architectural objects in a data storage device.

3. The method of claim 2, wherein the data storage device includes at least one of the following: a server, a database, a cloud server, and a network.

4. The method of claim 1, further comprising a step of manipulating the selected three-dimensional virtual architectural objects to a desired position in the virtual reality environment.

5. The method of claim 1, further comprising a step of viewing, through the virtual viewing device, the virtual reality environment and the virtual architectural objects from at least one perspective view.

6. The method of claim 1, further comprising a step of visually enhancing the three-dimensional virtual architectural objects through the user-controlled virtual control handle.

7. The method of claim 1, further comprising a step of viewing the virtual reality environment from at least one perspective.

8. The method of claim 1, further comprising a step of navigating the virtual reality environment through the user-controlled virtual viewing device.

9. The method of claim 1, wherein the three-dimensional virtual architectural objects comprise furniture.

10. The method of claim 1, wherein the virtual reality environment includes at least one of the following: a furniture showroom, a furniture store, a furniture auction site, a house, and a warehouse.

11. The method of claim 1, wherein the three-dimensional virtual architectural objects represent a mathematical representation of points and surfaces in the virtual reality environment that a rendering engine can translate into three dimensions.

12. The method of claim 1, wherein the image comprises a video of the virtual reality environment.

13. The method of claim 1, wherein the network web resource comprises a website.

14. A computer-implemented augmented method for manipulating furniture, the method comprising:
scanning a space to create a video which continuously displays a virtual reality environment corresponding to a physical scene having a plurality of objects;
processing the video with a variety of interior parameters;
interconnecting the video to a virtual reality program;
installing the virtual reality program into a user device;
enabling a user to navigate the virtual reality environment; and
displaying a selectable object within the virtual reality environment.

15. The method of claim 14, further comprising a step of receiving a selection of the selectable object to place an order of the selected objects.

16. The method of claim 14, wherein the physical scene includes at least one of the following: a furniture show-room, a furniture store, and a furniture auction site.

17. The method of claim 14, wherein the user selects the objects by scanning a QR code on the objects with a computing device.

18. The method of claim 14, further comprising a step of navigating, by the user, the virtual reality environment by manipulating the user device to perform at least one of the following functions: scroll left, scroll right, scroll up, scroll down, zoom-in, and zoom-out within the view of the selectable object.

19. A computer-implemented augmented system for manipulating furniture, the system comprising:
a data storage device operable to store a plurality of three-dimensional virtual architectural objects on a network web resource;
a user-controlled virtual control handle operatively connected to the network web resource;
a user-controlled virtual viewing device operatively connected to the network web resource and the virtual control handle; and
a client terminal communicating with the server to:
provide video to continuously display a virtual reality environment corresponding to a physical scene having a plurality of virtual architectural objects;
enable navigation within the virtual reality environment through the user-controlled virtual viewing device; and
display a selectable object within the virtual reality environment through the user-controlled virtual control handle.

20. The system of claim 19, wherein the user-controlled virtual viewing device and the user-controlled virtual control handle are operable to enable selecting the virtual architectural objects, scrolling left across the virtual reality environment, scrolling right across the virtual reality environment, scrolling up across the virtual reality environment, scrolling down across the virtual reality environment, zooming-in from the virtual reality environment, and zooming-out to the virtual reality environment for enhanced viewing of the virtual architectural objects.
